(19) United States
(12) Patent Application Publication
(10) Pub. No.: US 2012/0248993 A1
(43) Pub. Date: Oct. 4, 2012

(54) Method and Apparatus of Converting Output of Triac Dimmer to Control Operations of LED Lighting

(75) Inventor: Yuan Lin, Taipei (TW)

(73) Assignee: Lei Yueh Enterprise Co., Ltd., Taipei (TW)

(21) Appl. No.: 13/078,487

(22) Filed: Apr. 1, 2011

(51) Int. Cl. H05B 37/02

(52) U.S. Cl. 315/160; 315/291

(57) ABSTRACT

Various embodiments of the present disclosure pertain to converting output of a triode-for-alternating-current (TRIAC) dimmer to adjust lighting of one or more light-emitting diodes (LEDs). In one aspect, a method may receive a user-adjustable first signal from a dimmer, the first signal having an alternating current (AC) parameter that is adjustable by a user input to the dimmer; convert the first signal to a second signal that has a direct current (DC) parameter; and control operations of a load based at least in part on the second signal.

### BACKGROUND

1. Technical Field

Various embodiments of the present disclosure relate to lighting control and, more particularly, to method and apparatus of converting output of a dimmer to control operations of a light source.

2. Description of the Relevant Art

Triode-for-alternating-current (TRIAC) dimmers are commonly used for lighting control in various lighting applications, such as table lamps, floor lamps, and indoor lighting fixtures, where incandescent light bulbs are used. A TRIAC dimmer typically includes a resistor-capacitor (RC) circuit and basically operates by controlling the duty cycle of an alternating current (AC) voltage used to power the light source which may be one or more light bulbs. The TRIAC dimmer automatically cuts off the AC power to the light bulb circuit, for part of the half cycle of the sinusoidal wave of the AC power, every time the current reverses direction. The cut-off can occur either at the beginning or towards the end of each half cycle, depending on the design. The turn-on value of the AC voltage is based on a position of the dimmer switch's knob or slider. If the dimmer is turned to a brighter setting, it will switch on after cutting off power for a very short period of time (or, alternatively, it will stay on for the majority of the half cycle before switching off near the end of the half cycle). As the light bulb circuit is turned on for most of the cycle, more energy is supplied per second to the light bulb. Conversely, if the dimmer is set for lower lighting, it will wait until later in the half cycle to switch on (or, alternatively, it will stay on for a small portion of the half cycle and switch off for the remainder of the half cycle).

Light-emitting diodes (LEDs), on the other hand, typically need to be supplied with direct current (DC) power in order to operate properly without flickering. Although circuits that convert the output of a TRIAC dimmer from AC to DC for powering LEDs do exist, occasional ripples and/or surges produced by the TRIAC dimmer tend to cause permanent damages to the LEDs. Moreover, a typical operational curve of LEDs is usually not as linear as that of a typical operational curve of incandescent light bulbs. Thus, although TRIAC dimmers may be suitable for controlling linear loads such as incandescent light bulbs, using TRIAC dimmers to directly control non-linear loads such as LEDs may result in undesirable and unexpected consequences.

Presently there are various LED drivers for TRIAC dimmers made by various vendors on the market. The operational principle is generally switching on/off power supplied from the TRIAC dimmer to the LED light source. When the loading increases or when a TRIAC dimmer supplies power to multiple such drivers, the high-frequency switching within the drives tend to result in cross-interference or impact on the operation of the TRIAC.

As the control circuit of the driver requires certain level of power in order to function, it may not function properly when the power output from the TRIAC dimmer is less than 30% of maximum (corresponding to the dimmer's knob or slider set to 30% of lighting or less). Additionally, with the different designs, the switch-on/switch-off values of TRIAC dimmers as well as the associated phase differential are different from vendor to vendor. TRIAC dimmer solutions tend to be vendor-specific.

Furthermore, as varying number of drivers and length of wiring results in varying input impedance, vendors typically require or suggest using one driver with a corresponding TRIAC dimmer in order for the circuits to function with specifications. However, such one-to-one configuration is usually used in table lamp and floor lamp applications. In contrast, most lighting applications require a one-to-four-or more configuration in that a single lighting control corresponds to four or more light sources. In the one-to-one configuration, since the lighting control is in the lighting fixture or along the power line, it is better to use a pulse-width modulation (PWM) circuit or other suitable circuits to control operations of LED lighting, as opposed to using a TRIAC dimmer or a complicated TRIAC dimmer driver circuit.

### SUMMARY

Various embodiments of the present disclosure pertain to techniques of controlling operations of LED lighting by using the output of a TRIAC dimmer not as a power source but as a lighting control signal, thus achieving smooth adjustment of the LED lighting.

In one aspect, a method may comprise: receiving a user-adjustable first signal from a dimmer, the first signal having an AC parameter that is adjustable by a user input to the dimmer; converting the first signal to a second signal that has a DC parameter; and controlling operations of a load based at least in part on the second signal.

In one embodiment, converting the first signal to a second signal may comprise converting the first signal to a low-voltage DC signal using a photocoupler, a transformer, a heat-sensing circuit, a motor speed-sensing circuit, a resistor-capacitor (RC) circuit, a circuit that senses an electrical or magnetic parameter of the first signal, or a combination thereof.

In one embodiment, controlling operations of a load based at least in part on the second signal may comprise generating a third signal based at least in part on the second signal to control the load, the third signal comprising a pulse-width modulated (PWM) signal, a parallel digital signal, a serial digital signal, a signal having a DC voltage variable between 0 volt and 10 volt, a voltage signal having varying DC voltage levels, a signal representative of an impedance value, or a combination thereof.

In one embodiment, controlling operations of a load based at least in part on the second signal may comprise: receiving a first source of power at a controller unit that is coupled to the power supply unit; receiving a second source of power at a power supply unit, the second source of power different from the first source of power; and generating a third signal, by the controller unit based on the second signal, to adjust an output of the power supply unit which controls the operations of the load.

In one embodiment, receiving a user-adjustable first signal from a dimmer may comprise receiving the user-adjustable first signal from a TRIAC dimmer; and controlling operations of a load based at least in part on the second signal comprises controlling an intensity of emitted light, a color of the emitted light, or both, of one or more LEDs based at least in part on the second signal.

In one embodiment, receiving a user-adjustable first signal from a dimmer may comprise receiving a respective user-adjustable first signal from each of a plurality of TRIAC dimmers, each of the plurality of first signals having a respective AC parameter that is adjustable by a respective user input to the respective TRIAC dimmer; converting the first signal to a second signal that has a DC parameter comprises generating one or more second signals each of which having a DC parameter based on a combination of the plurality of first signals; and controlling operations of a load based at least in part on the second signal comprises controlling an intensity of emitted light, a color of the emitted light, or both, of one or more LEDs based at least in part on the one or more second signals.

In one embodiment, receiving a user-adjustable first signal from a dimmer comprises receiving a user-adjustable first signal from a TRIAC dimmer, the first signal having an AC parameter that is adjustable by a user input to the TRIAC dimmer; converting the first signal to a second signal comprises converting the first signal to a plurality of second signals, each of the plurality of second signals having a respective DC parameter; and controlling operations of a load based at least in part on the second signal comprises controlling an intensity of emitted light, a color of the emitted light, or both, of one or more LEDs based at least in part on the plurality of second signals.

In one aspect, an apparatus may comprise: a translator unit that, in response to receiving a first signal that is sinusoidal in nature with a user-adjustable duty cycle, generates a second signal, the second signal comprising a PWM signal, a parallel digital signal, a serial digital signal, a signal having a DC voltage variable between 0 volt and 10 volt, a voltage signal having varying DC voltage levels, a signal representative of an impedance value, or a combination thereof; and a power supply unit, coupled to the translator unit, that generates a third signal to power a load in response to receiving the second signal and being coupled to the load, the third signal being variable according to a setting of the second signal.

In one embodiment, the translator unit may comprise: a signal processing unit that generates a fourth signal that is DC in nature in response to receiving the first signal; and a controller unit, coupled to the signal processing unit, that generates the second signal in response to receiving the fourth signal. The signal processing unit may generate the fourth signal using a photocoupler, a transformer, a heat-sensing circuit, a motor speed-sensing circuit, an RC circuit, a circuit that senses an electrical or magnetic parameter of the first signal, or a combination thereof.

In one embodiment, the power supply unit may comprise a controllable power supply unit, coupled to receive the second signal and a user-input control signal, which generates the third signal in response to receiving the second signal and the user-input control signal.

In one embodiment, the apparatus may further comprise: one or more dimmer units coupled to the translator unit, each of the one or more dimmer units generating a respective first signal according to a setting of a respective user input in response to receiving the respective user input; and at least one LED as the load coupled to receive the variable power from the power supply unit. The translator unit may be coupled to receive the one or more first signals from the one or more dimmer units and generates the second signal according to a combination of the one or more first signals.

In another aspect, an apparatus may comprise: a dimmer unit that, in response to receiving a user input, generates a first signal, the first signal being sinusoidal in nature and having a duty cycle adjustable according to a setting the user input; and a translator unit, coupled to the dimmer unit, that generates a second signal in response to receiving the first signal, the second signal comprising a PWM signal, a parallel digital signal, a serial digital signal, a signal having a DC voltage variable between 0 volt and 10 volt, a voltage signal having varying DC voltage levels, a signal representative of an impedance value, or a combination thereof.

In one embodiment, the translator unit may be configured to receive a plurality of output signals from a plurality of dimmer units and generate the second signal according to a combination of the plurality of output signals, each of the output signals being sinusoidal in nature and having a respective user-adjustable duty cycle. Alternatively, the translator unit may be configured to receive one or more output signals from one or more dimmer units and generate respective one or more second signals according to a combination of the one or more output signals, each of the one or more output signals being sinusoidal in nature and having a respective user-adjustable duty cycle.

In one embodiment, the translator unit may comprise: a signal processing unit that generates a third signal that is DC in nature in response to receiving the first signal; and a controller unit, coupled to the signal processing unit, that generates the second signal in response to receiving the third signal. The signal processing unit may generate the fourth signal using a photocoupler, a transformer, a heat-sensing circuit, a motor speed-sensing circuit, an RC circuit, a circuit that senses an electrical or magnetic parameter of the first signal, or a combination thereof.

In one embodiment, the apparatus may further comprise: a power supply unit, coupled to the translator unit, that generates a fourth signal to power a load in response to receiving the second signal and being coupled to the load, a value of a parameter of the fourth signal being set according to the second signal. The power supply unit may comprise a controllable power supply unit, coupled to receive the second signal and a user-input control signal, which generates the third signal in response to receiving the second signal and the user-input control signal.

In one embodiment, the apparatus may further comprise one or more LEDs as the load coupled to be powered by the fourth signal of the power supply unit, the fourth signal controlling an intensity of light emitted by the one or more LEDs, a color of the light emitted by the one or more LEDs, or both.

In one embodiment, the dimmer unit may be powered by a first power source, and the power supply unit may be powered by a second power source that is different than the first power source.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram of an apparatus in accordance with a first embodiment to the present disclosure.

FIG. 2 is a block diagram of an apparatus in accordance with a second embodiment to the present disclosure.

FIG. 3 is a block diagram of a first scheme in accordance with an embodiment to the present disclosure.

FIG. 4 is a block diagram of a second scheme in accordance with an embodiment to the present disclosure.

FIG. 5 is a block diagram of a third scheme in accordance with an embodiment to the present disclosure.

FIG. 6 is a block diagram of a fourth scheme in accordance with an embodiment to the present disclosure.

FIG. 7 is a block diagram of a fifth scheme in accordance with an embodiment to the present disclosure.

FIG. 8 is a flowchart of a process in accordance with an embodiment to the present disclosure.

### DETAILED DESCRIPTION

### Overview

Various embodiments of the present disclosure pertain to techniques of controlling operations of LED lighting by using the output of a TRIAC dimmer not as a power source but as a lighting control signal. The AC signal outputted or otherwise controlled by the TRIAC dimmer, which may be suitable for driving linear loads such as incandescent light bulbs but not necessarily suitable for non-linear loads such as LEDs, is converted to a low-voltage DC signal, e.g., a pulse-width modulated signal, which can be used to control and drive non-linear loads such as LEDs.

This proposed inventive technique advantageously addresses a number of issues mentioned above. For example, interference between the detection signal of the driver of the TRIA dimmer and the power supply can be avoided. Issues with normal operation of the driver circuit associated with low output power from the TRIAC dimmer, e.g., below 30%, or small duty cycle are also eliminated in solutions adopting the proposed technique.

As the proposed technique can be implemented with available processors/microprocessors and sensing technology, the costs of a solution utilizing the proposed technique is believed to be lower than a solution utilizing a TRIAC dimmer and its relatively complicated sampling and voltage alternation circuits. Although the proposed technique may require an additional power line, such requirement is believed to be a minor issue as techniques for incorporating an additional power line, e.g., the double switch used to control hallway lighting, are available and commonly adopted.

### Illustrative Apparatuses

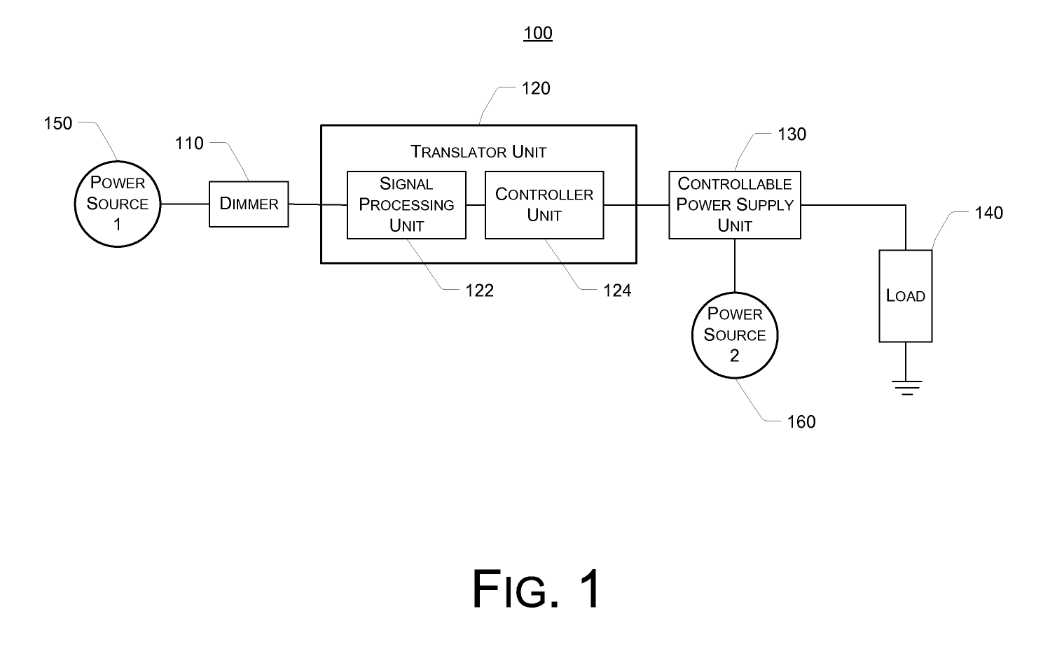

FIG. 1 is a block diagram of an apparatus 100 in accordance with a first embodiment to the present disclosure.

In one embodiment, the apparatus 100 comprises a translator unit 120. In another embodiment, the apparatus 100 comprises the translator unit 120 and a power supply unit 130. In yet another embodiment, the apparatus 100 comprises the translator unit 120 and a dimmer 110. In still another embodiment, the apparatus 100 comprises the translator unit 120, the power supply unit 130, and the dimmer 110. In a further embodiment, the apparatus 100 comprises the translator unit 120, the power supply unit 130, the dimmer 110, and a load 140.

The translator unit 120 is coupled between the dimmer 110 and the power supply unit 130. The dimmer 110 is coupled to receive power from a first power source 150. The power supply unit 130 is coupled to receive power from a second power source 160. The power supply unit 130 is also coupled to supply power to drive the load 140. The load 140 may be a non-linear load, a non-linear light source for example. In one embodiment, the load 140 may be one or more LEDs. In one embodiment, the one or more LEDs of the load 140 may comprise one or more single-color LEDs. In another embodiment, the one or more LEDs of the load 140 may comprise one or more variable-color LEDs such as RGB, RGBW, RGBA or RGGB to allow for options of a combination of different colors in lighting.

The dimmer 110 may be a TRIAC dimmer the operation of which is briefly described above and commonly used in residential and commercial lighting applications. The dimmer 110 receives electrical power from the first power source 150, e.g., AC power mains, and outputs an AC power signal that is AC in nature, having one or more AC parameters, e.g., current and voltage. The AC power signal outputted by the dimmer 110 is user-adjustable according to a user input to the dimmer 110 such as, for example, a position of a knob or slider on the dimmer 110 as set by a user. Depending on the setting of the knob or slider on the dimmer 110 by the user, the duty cycle of the AC power signal outputted by the dimmer 110 is adjusted accordingly, so as to control lighting in conventional lighting applications. Here, however, the AC power signal from the dimmer 110 is provided to the translator unit 120 according to embodiments of the present disclosure.

In response to receiving the AC power signal from the dimmer 110, the translator unit 120 generates a power control signal that is provided to the power supply unit 130. The power control signal is DC in nature, having one or more DC parameters. In one embodiment, the power control signal may be a PWM signal. In one embodiment, the power control signal may have a DC voltage that varies between 0 volt and 10 volts according to the 0-10V lighting control protocol which is commonly used in fluorescent lighting applications. In another embodiment, the power control signal may be a voltage signal having varying DC voltage levels. In a further embodiment, the power control signal may be a signal representative of an impedance value. In yet another embodiment, the power control signal may be a parallel digital signal, such as a P-bit signal that carries P bits of digital data in parallel where P is a positive integer greater than 1, for example, 4 or 8. The data may be in the binary-coded decimal (BCD) format or any other suitable format. In still another embodiment, the power control signal may be a serial digital signal. The serial digital signal may comprise a series of DC voltage levels the values of which make up the content of the signal. The serial digital data may comprise groups of bits of data where each group of bits of data includes bits of address data, bits of content data and bits of termination data, arranged in that order. In another embodiment, the power control signal may be a wireless signal transmitted by the translator unit 120 wirelessly, e.g., according to the DMX protocol. Alternatively, the power control signal outputted by the translator unit 120 may comprise a combination of the above various forms of DC signals.

The power supply unit 130, in response to receiving the power control signal from the translator unit 120, generates a lighting control signal to power the load 140 when the load 140 is coupled to be powered by the power supply unit 130. The lighting control signal is variable according to a setting of the power control signal.

Accordingly, with the above described arrangement, the AC power from the first power source 150, after being adjusted by the dimmer 110 in accordance with a user input to the dimmer 110, is provided in the form of the AC power signal to the translator unit 120 rather than being used to drive the load 140 directly. Based on the AC power signal, the translator unit 120 generates the power control signal to control the power supply unit 130, which in turn generates the lighting control signal to drive the load 140. Thus, given that the output of the dimmer 110 is not used to directly drive the load 140, which may be one or more LEDs, the proposed inventive technique advantageously addresses a number of issues such as, for example, interference between the detection signal of the driver of the TRIA dimmer and the power supply can be avoided. Additionally, issues with normal operation of the driver circuit associated with low output power from the TRIAC dimmer, e.g., below 30%, or small duty cycle will also be eliminated in solutions adopting this technique.

In one embodiment, as shown in FIG. 1, the translator unit 120 may comprise a signal processing unit 122 and a controller unit 124. The signal processing unit 122 is coupled to receive the AC power signal from the dimmer 110 and, in response, generates a low-voltage DC processed signal that is DC in nature and can be processed by the controller unit 124. The controller unit 124, coupled to the signal processing unit 122, generates the power control signal in response to receiving the processed signal from the signal processing unit 122.

The signal processing unit 122 may be configured such that one or more of a variety of methods may be utilized in the signal processing unit 122 to measure and convert the AC power signal received from the dimmer 110 to the low-voltage DC processed signal that is provided to the controller unit 124. In one embodiment, a photocoupler (also known as an opto-isolator, optocoupler, or optical isolator) which may be a CdS sensor may be utilized. In another embodiment, a transformer may be utilized. In another embodiment, a heat-sensing circuit may be utilized. In yet another embodiment, a motor speed-sensing circuit may be utilized. For example, the AC power signal from the dimmer 110 may be provided to an AC motor which may be part of the signal processing unit 122, such that the speed of rotation of the AC motor is dictated by the AC power signal. By detecting, sensing or otherwise measuring the speed at which the motor rotates, at least one of the AC parameters, such as current or voltage of the AC power signal, can be determined and processed by the signal processing unit 122. In still another embodiment, an RC circuit may be utilized. Alternatively, a circuit that senses an electrical or magnetic parameter of the AC power signal may be utilized. In one embodiment, a combination of more than one of the above methods may be utilized.

The controller unit 124 may be a processor, e.g., a microprocessor, a processor and associated circuitry on a printed circuit board (PCB), or circuitry on a PCB. A set of programming code, e.g., instructions, may be stored or otherwise embedded in the controller unit 124 to control operations of the controller unit 124. Upon performing computation based on the processed signal received from the signal processing unit 122, the controller unit 124 generates the power control signal in accordance with the set of instructions stored therein to control operations of the power supply unit 130.

The power supply unit 130 may comprise a controllable power supply unit, coupled to receive the power control signal form the translator unit 120 and, additionally, a user-input control signal, which generates the lighting control signal in response to receiving the power control signal and the user-input control signal. For example, the user-input control signal may be received at a user input port of the power supply unit 130, and controls the power level, e.g., current and/or voltage, phase, or frequency of the lighting control signal. In one embodiment, the power supply unit 130 may include an internal battery that may be used to power the power supply unit 130, the load 140, the translator unit 120, or a combination thereof.

The lighting control signal drives the load 140. In embodiments where the load 140 comprises one or more LEDs, the lighting control signal powers the one or more LEDs as well as the intensity, color, or both, of the light emitted by each, some or all of the one or more LEDs. The lighting control signal may be directly supplied to the load 140 to drive the load 140. Alternatively, the lighting control signal may be used to control one or more switches to switch on or off power supplied to the load 140.

The power supply unit 130 is powered by the second power source 160. In one embodiment, the second power source 160 is independent from and different than the first power source 150, and may be an AC power source or a DC power source, e.g., a battery, a photovoltaic device or a DC power generator. This arrangement beneficially allows the power supply unit 130 to drive and control the operations of the load 140 while being powered by an independent power source without interference. Alternatively, the second power source 160 may be the same as the first power source 150. In one embodiment, both the translator unit 120 and the power supply unit 130, and therefore the load 140 which receives power from the power supply unit 130, are powered by the second power source 160.

As shown in FIG. 1, the signal processing unit 122 and the controller unit 124 of the translator unit 120 are packaged in a casing, or housing. In one embodiment, the translator unit 120 and either or both of the power supply unit 130 and the load 140 (e.g., one or more LEDs) may be packaged in the same casing, or housing.

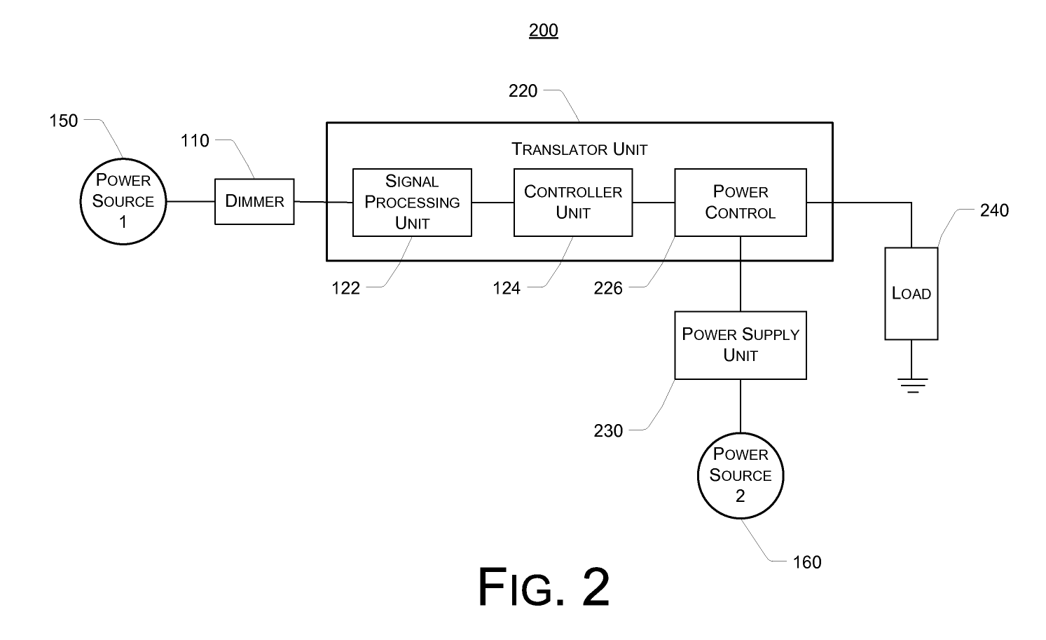

FIG. 2 is a block diagram of an apparatus 200 in accordance with a second embodiment to the present disclosure.

In one embodiment, the apparatus 200 comprises a translator unit 220. In another embodiment, the apparatus 200 comprises the translator unit 220 and a power supply unit 230. In yet another embodiment, the apparatus 200 comprises the translator unit 220 and the dimmer 110. In still another embodiment, the apparatus 200 comprises the translator unit 220, the power supply unit 230, and the dimmer 110. In a further embodiment, the apparatus 200 comprises the translator unit 220, the power supply unit 230, the dimmer 110, and a load 240.

The translator unit 220 is coupled between the dimmer 110 and the load 240. The dimmer 110 is coupled to receive power from a first power source 150. The power supply unit 230 is coupled to receive power from a second power source 160. The load 240 may be a non-linear load, a non-linear light source for example. In one embodiment, the load 240 may be one or more LEDs. In one embodiment, the one or more LEDs of the load 240 may comprise one or more single-color LEDs. In another embodiment, the one or more LEDs of the load 240 may comprise one or more variable-color LEDs such as RGB, RGBW, RGBA or RGGB to allow for options of a combination of different colors in lighting.

In one embodiment, as shown in FIG. 2, the translator unit 220 may comprise the signal processing unit 122, the controller unit 124, and a power control 226. As described above, the signal processing unit 122 is coupled to receive the AC power signal from the dimmer 110 and, in response, generates a low-voltage DC processed signal that is DC in nature and can be processed by the controller unit 124. The controller unit 124, coupled to the signal processing unit 122, generates the power control signal in response to receiving the processed signal from the signal processing unit 122.

The dimmer 110, the signal processing unit 122 and the controller unit 124 of FIG. 2 are identical the dimmer 110, the signal processing unit 122 and the controller unit 124 of FIG. 1 as described above. Accordingly, in the interest of brevity, the operations and structures of the dimmer 110, the signal processing unit 122 and the controller unit 124 will not be repeated herein.

The power control 226 receives the power control signal from the controller unit 124 and generates a lighting control signal according to the power control signal to drive the load 140. In one embodiment, the lighting control signal is directly applied to the load 140 to control the operations of the load 140 directly. Alternatively, the lighting control signal may be used to control one or more switches to switch on or off power supplied to the load 140.

The power control 226 receives its power from the power supply unit 230, which is in turn powered by the second power source 160. The power supply unit 230 may be a DC power supplier and thus the output of the power supply unit 230 may have a constant current level or a constant voltage level. In one embodiment, the second power source 160 is independent from and different than the first power source 150, and may be an AC power source or a DC power source, e.g., a battery, a photovoltaic device or a DC power generator. In one embodiment, both the translator unit 220 and the power supply unit 230, and therefore the load 240 which receives power from the power supply unit 130, are powered by the second power source 160. In another embodiment, the power supply unit 230 and the second power source 160 may together be a battery that supplies DC power to the translator unit 220. In yet another embodiment, the power supply unit 230 may include an internal battery that may be used to power the power supply unit 230, the load 240, the translator unit 220, or a combination thereof. In any case, this advantageously allows the control of the operations of the load 240 to be supported by an independent power source without interference. Alternatively, the second power source 160 may be the same as the first power source 150.

As shown in FIG. 2, the signal processing unit 122, the controller unit 124, and the power control 226 of the translator unit 220 are packaged in a casing, or housing. In one embodiment, the translator unit 220 and either or both of the power supply unit 230 and the load 240 (e.g., one or more LEDs) may be packaged in the same casing, or housing.

### Illustrative Schemes

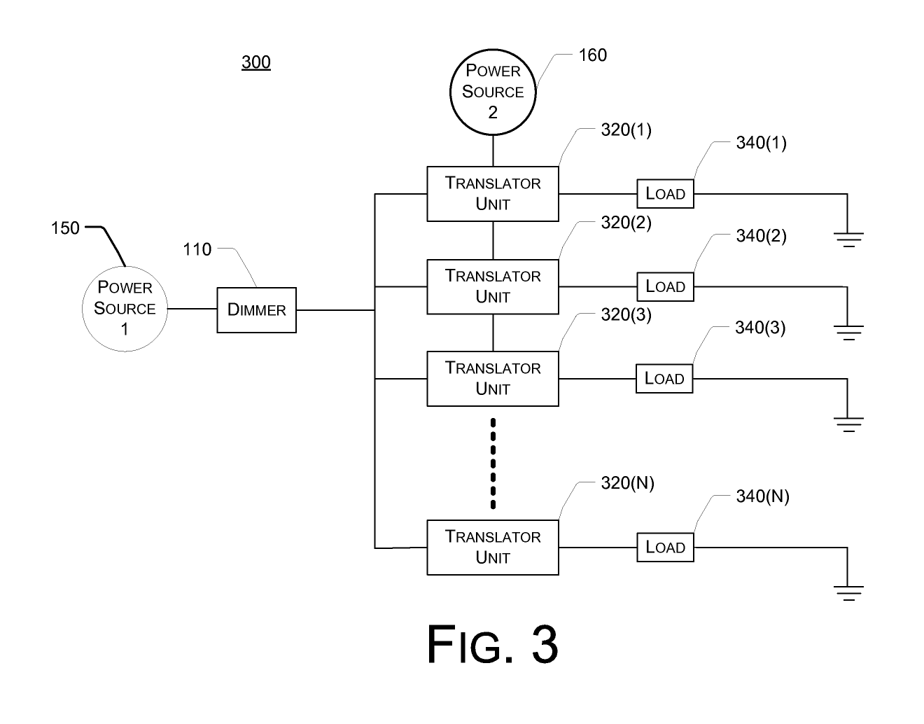

FIG. 3 is a block diagram of a first scheme 300 in accordance with an embodiment to the present disclosure.

According to the first scheme 300, a single dimmer 110 is coupled to control a plurality of translator units 320(1)-320(N), where N is a positive integer greater than 1. Each of the translator units 320(1)-320(N) drives a respective one of the loads 340(1)-340(N). In one embodiment, at least one of the loads 340(1)-340(N) may be one or more LEDs. In one embodiment, the one or more LEDs may comprise one or more single-color LEDs. In another embodiment, the one or more LEDs may comprise one or more variable-color LEDs such as RGB, RGBW, RGBA or RGGB to allow for options of a combination of different colors in lighting.

Each of the translator units 320(1)-320(N) may be the translator unit 120 of FIG. 1 or the translator unit 220 of FIG. 2, and may or may not include the power supply unit 130 or the power supply unit 230. However, so as not to clutter FIG. 3, a separate power supply unit to each of the translator units 320(1)-320(N) is not shown in FIG. 3 in the event that the translator units 320(1)-320(N) do not each include a power supply unit.

The dimmer 110 is powered by the first power source 150. The plurality of translator units 320(1)-320(N) are powered by the second power source 160. In the interest of brevity, detailed description of the first power source 150 and the second power source 160 will not be repeated herein.

Given that the translator units 320(1)-320(N) are powered by a separate power source independent of that of the dimmer 110, electric signals in the circuitry of the translator units 320(1)-320(N) do not, or will likely not, be subject to interference by or resonance with the dimmer 110. Further, as the AC power signal provided by the dimmer 110 is received by the signal processing unit 122 of each of the translator units 320(1)-320(N), the power control signals outputted by the translator units 320(1)-320(N) do not differ significantly from one another despite the fact that the AC power signal form the dimmer 110 is provided to the plurality of translator units 320(1)-320(N). This characteristic advantageously enables uniformity in performance in the lighting of the various LEDs of the loads 340(1)-340(N) when the number N varies.

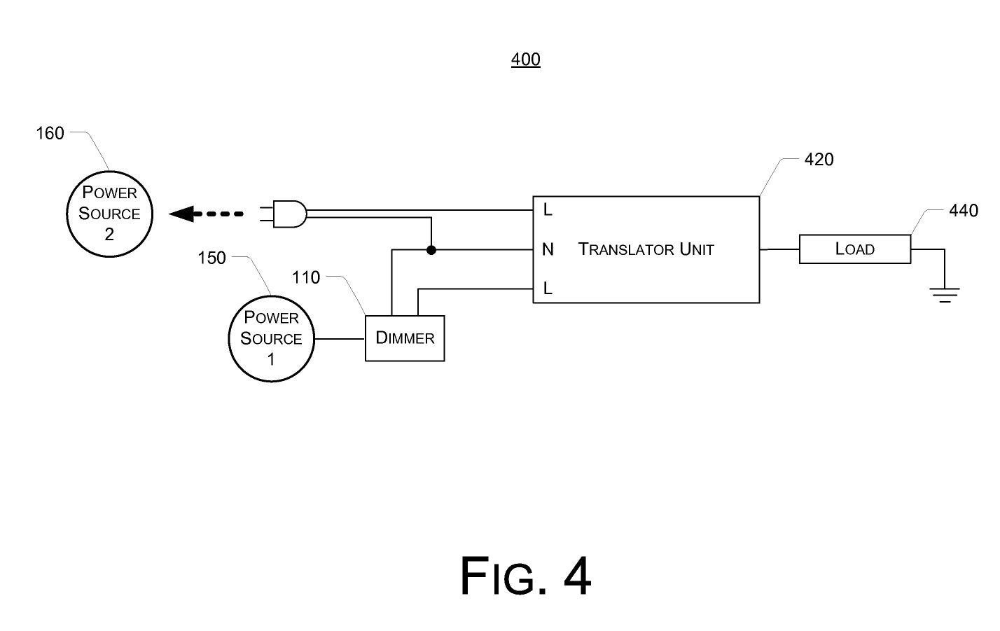

FIG. 4 is a block diagram of a second scheme 400 in accordance with an embodiment to the present disclosure.

The translator unit 420 may be the translator unit 120 of FIG. 1 or the translator unit 220 of FIG. 2, and may or may not include the power supply unit 130 or the power supply unit 230. However, so as not to clutter FIG. 4, a separate power supply unit to the translator unit 420 is not shown in FIG. 4 in the event that the translator unit 420 does not include the power supply unit 130 or the power supply unit 230.

The second scheme 400 illustrates an embodiment of wiring to power the dimmer 110 and the translator unit 420. As shown in FIG. 4, the dimmer 110 may be powered by the first power source 150 and the translator unit 420 may be powered by the second power source 160.

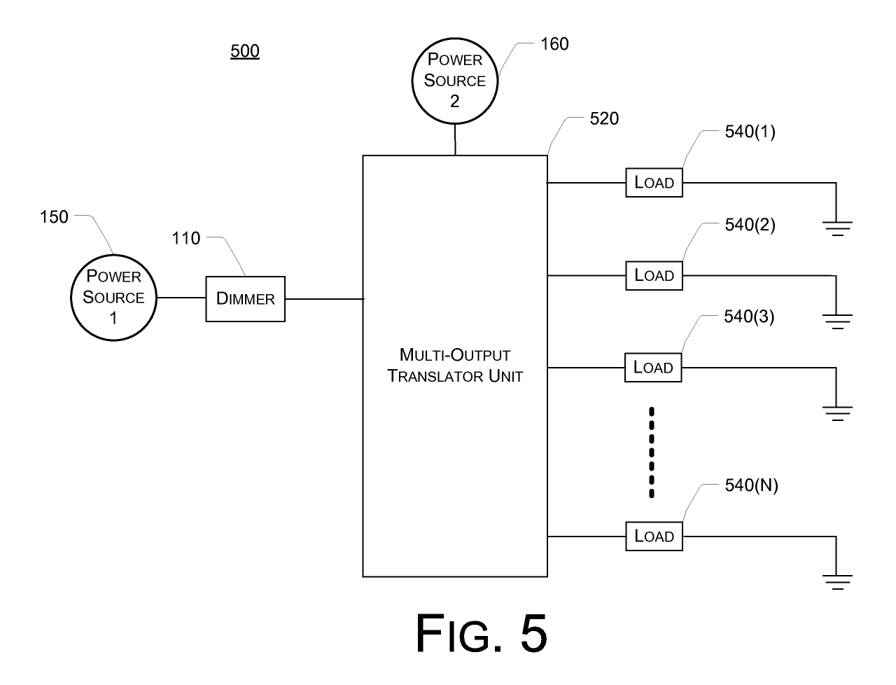

FIG. 5 is a block diagram of a third scheme 500 in accordance with an embodiment to the present disclosure.

According to the third scheme 500, a single dimmer 110 is coupled to control a translator unit 520 which in turn drives a plurality of loads 540(1)-540(N), where N is a positive integer greater than 1. In one embodiment, at least one of the loads 340(1)-340(N) may comprise one or more LEDs. In one embodiment, the one or more LEDs may comprise one or more single-color LEDs. In another embodiment, the one or more LEDs may comprise one or more variable-color LEDs such as RGB, RGBW, RGBA or RGGB to allow for options of a combination of different colors in lighting.

As the translator unit 520 drives the plurality of loads 540(1)-540(N), the translator unit 520 is a multi-output translator unit. In one embodiment, the translator unit 520 has multiple output channels, e.g., each provided by a respective one of multiple controller units 124, each of which provides a respective power control signal for the control of the operations of the respective one of the loads 540(1)-540(N). That is, each of the plurality of power control signals is provided to a respective controllable power supply unit 130 or a respective power control 226, which in turn outputs a respective lighting control signal to drive the respective one of the loads 540(1)-540(N). Alternatively, the translator unit 540 provides a power control signal, e.g., by a single controller unit 124, to a power supply unit, which may be similar to the controllable power supply unit 130 or the power control 226 but different in that it has multiple output channels each of which provides a respective lighting control signal to drive the respective one of the loads 540(1)-540(N).

Regardless of what the case may be, the number of the output channels may vary depending on the need of the actual application. For example, N may be 3, 4, or a multiple of 3 or 4. In one embodiment, the multiple lighting control signals may be identical and as a result the loads 540(1)-540(N) operate in an identical or similar manner. In another embodiment, each or some of the multiple lighting control signals may have different values from one another, thus controlling the loads 540(1)-540(N) to operate differently. For example, when the loads 540(1)-540(N) comprise a plurality of LEDs, the LEDs may be controlled in such a way that different groups of the LEDs emit light in different intensities, colors or both, based on the instructions in the one or multiple controller units 124 of the translator unit 520. The LEDs may be grouped into groups of 3 or 4 LEDs. Groups of 3 LEDs may each be an RGB light source. Groups of 4 LEDs may each be an RGGB, RGBA or RGBW light source. Accordingly, the intensity of the light emitted by the LEDs may be proportional to the user input setting on the dimmer 110. Moreover, the LEDs may be switched on/off in a sequential order or in other fashion so as to result in a variety of lighting effects, depending on the instructions in the one or multiple controller units 124 of the translator unit 520.

The dimmer 110 is powered by the first power source 150. The translator unit 520 is powered by the second power source 160. In the interest of brevity, detailed description of the first power source 150 and the second power source 160 will not be repeated herein.

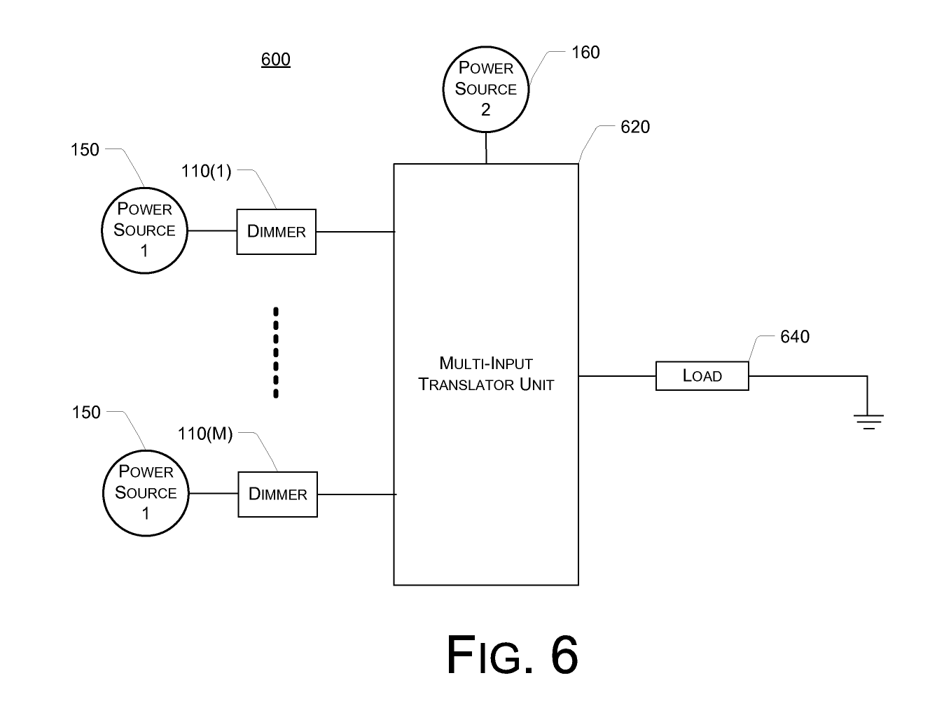

FIG. 6 is a block diagram of a fourth scheme 600 in accordance with an embodiment to the present disclosure.

According to the fourth scheme 600, a plurality of dimmers 110(1)-110(M) are coupled to control a translator unit 620 which in turn drives a load 640, where M is a positive integer greater than 1. Each of the plurality of dimmers 110(1)-110(M) generates a respective AC power signal according to a setting of a respective user input in response to receiving the respective user input, e.g., adjustment of a slider or knob on the respective one of the dimmers 110(1)-110(M). In one embodiment, the load 640 may be one or more LEDs. In one embodiment, the one or more LEDs may comprise one or more single-color LEDs. In another embodiment, the one or more LEDs may comprise one or more variable-color LEDs such as RGB, RGBW, RGBA or RGGB to allow for options of a combination of different colors in lighting.

As the translator unit 620 receives the plurality of AC power signals from the plurality of dimmers 110, the translator unit 520 is a multi-input translator unit. In one embodiment, the translator unit 620 may include a plurality of signal processing units 122 each receiving and processing a respective AC power signal from a respective one of the plurality of dimmers 110. In another embodiment, the translator unit 620 may include a signal processing unit that, while similar to the signal processing unit 122, has multiple input channels to receive the plurality of AC power signals from the plurality of dimmers 110(1)-110(M) to process the plurality of AC power signals. In such case the processed signal generated by the signal processing unit is based on a combination of the plurality of AC power signals.

Accordingly, LEDs of the load 620 controlled by the multi-output translator unit 620 may produce different lighting effects than in the case when a single dimmer 110 is used. For example, assuming there are two dimmers 110 in the configuration and that signal resolution can be as fine as 1% of the AC power signal, there may be as many as 10,000 lighting effects (100×100=10,000) with two dimmers 110. As another example, assuming there are three dimmers 110 in the configuration, there may be as many as 1,000,000 lighting effects (100×100×100=1,000,000) with three dimmers 110.

The plurality of dimmers 110(1)-110(M) are powered by the first power source 150. The translator unit 620 is powered by the second power source 160. In the interest of brevity, detailed description of the first power source 150 and the second power source 160 will not be repeated herein.

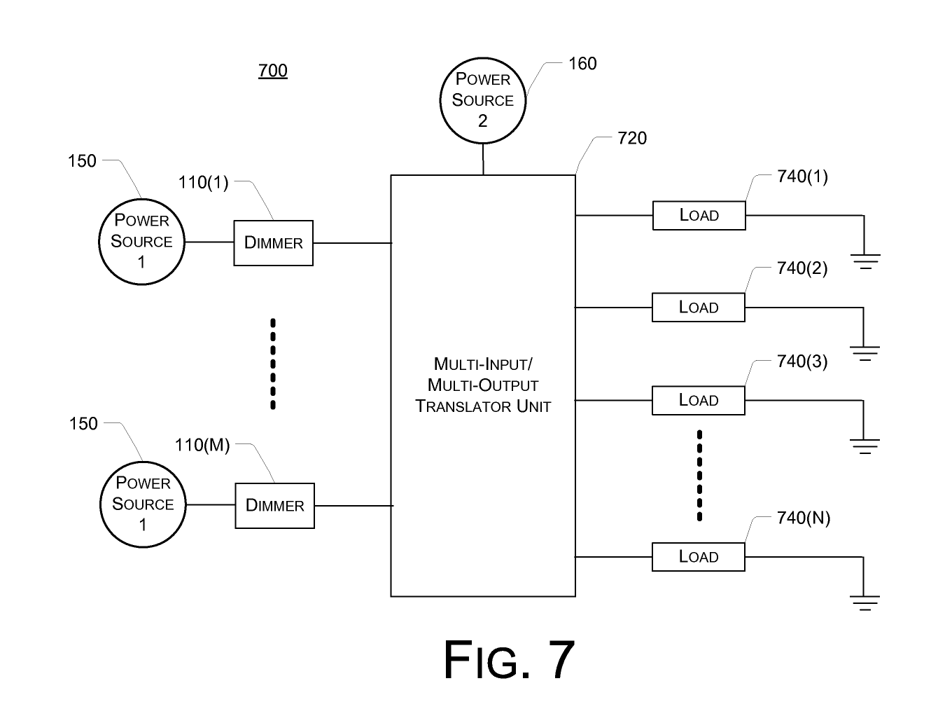

FIG. 7 is a block diagram of a fifth scheme 700 in accordance with an embodiment to the present disclosure.

According to the fifth scheme 700, a plurality of dimmers 110(1)-110(M) are coupled to control a translator unit 720 which in turn drives a plurality of loads 740(1)-740(N), where each of M and N is a positive integer greater than 1. Each of the plurality of dimmers 110(1)-110(M) generates a respective AC power signal according to a setting of a respective user input in response to receiving the respective user input, e.g., adjustment of a slider or knob on the respective one of the dimmers 110(1)-110(M). In one embodiment, at least one of the loads 740(1)-740(N) may comprise one or more LEDs. In one embodiment, the one or more LEDs may comprise one or more single-color LEDs. In another embodiment, the one or more LEDs may comprise one or more variable-color LEDs such as RGB, RGBW, RGBA or RGGB to allow for options of a combination of different colors in lighting.

As the translator unit 720 receives the plurality of AC power signals from the plurality of dimmers 110(1)-110(M) and controls the operations of the plurality of the loads 740(1)-740(N), the translator unit 720 is a multi-input/multi-output translator unit. The translator unit 720 may include a plurality of signal processing units 122 or a signal processing unit 122 that has multiple input channels, and may include a plurality of controller units 124 or a controller unit 124 that has multiple output channels. In the interest of brevity, detailed description of the translator unit 720 will not be provided herein.

The multi-input/multi-output translator unit 720 combines the functions of the translator unit 520 and the translator unit 620. With inputs from the plurality of dimmers 110(1)-110(M), the one or more controller units 124 of the translator unit 720 may be programmed to control the translator unit 720 to result in a great variety of lighting effects by the LEDs of the plurality of loads 720(1)-720(N), whether in intensity, color, or timing of switching on or off. As explained above, when there are two dimmers 110, there may be a total of 10,000 lighting effects produced. When there are three dimmers 110, there may be a total of 1,000,000 lighting effects produced.

### Illustrative Process

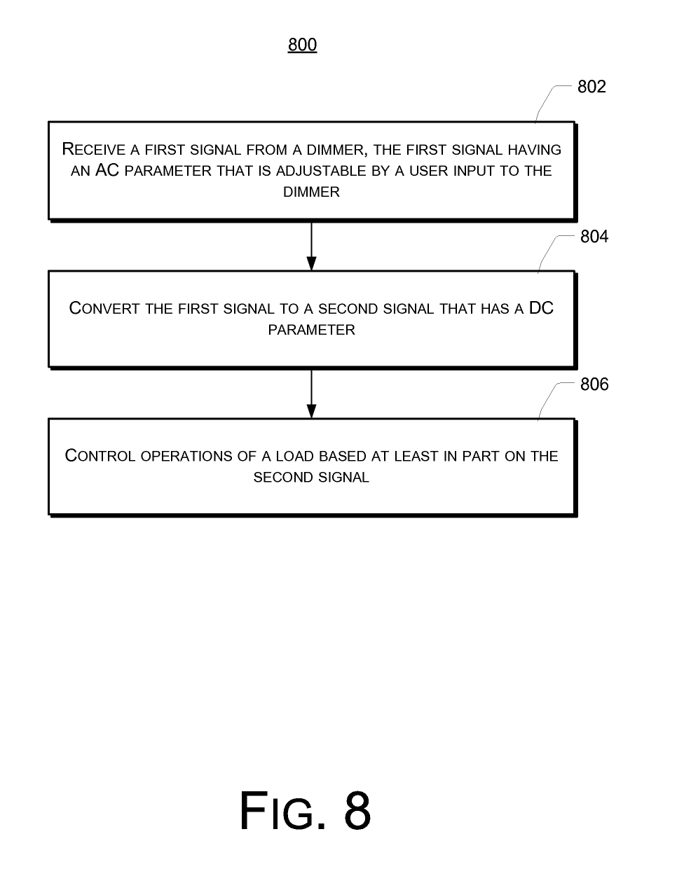

FIG. 8 is a flowchart of a process 800 in accordance with an embodiment to the present disclosure.

At 802, the method 800 receives a user-adjustable first signal from a dimmer, the first signal having an AC parameter that is adjustable by a user input to the dimmer. At 804, the method 800 converts the first signal to a second signal that has a DC parameter. At 806, the method 600 controls operations of a load based at least in part on the second signal. Accordingly, the process 800 describes the general operation of the apparatus 100 and the apparatus 200 as applied in the schemes 300, 400, 500, 600 and 700.

In one embodiment, converting the first signal to a second signal may comprise converting the first signal to a low-voltage DC signal using a photocoupler, a transformer, a heat-sensing circuit, a motor speed-sensing circuit, an RC circuit, a circuit that senses an electrical or magnetic parameter of the first signal, or a combination thereof.

In one embodiment, controlling operations of a load based at least in part on the second signal may comprise generating a third signal based at least in part on the second signal to control the load, the third signal comprising a PWM signal, a parallel digital signal, a serial digital signal, a signal having a DC voltage variable between 0 volt and 10 volt, a voltage signal having varying DC voltage levels, a signal representative of an impedance value, or a combination thereof.

In one embodiment, controlling operations of a load based at least in part on the second signal may comprise: receiving a first source of power at a controller unit that is coupled to the power supply unit; receiving a second source of power at a power supply unit, the second source of power different from the first source of power; and generating a third signal, by the controller unit based on the second signal, to adjust an output of the power supply unit which controls the operations of the load.

In one embodiment, receiving a user-adjustable first signal from a dimmer may comprise receiving the user-adjustable first signal from a TRIAC dimmer; and controlling operations of a load based at least in part on the second signal comprises controlling an intensity of emitted light, a color of the emitted light, or both, of one or more LEDs based at least in part on the second signal.

In one embodiment, receiving a user-adjustable first signal from a dimmer may comprise receiving a respective user-adjustable first signal from each of a plurality of TRIAC dimmers, each of the plurality of first signals having a respective AC parameter that is adjustable by a respective user input to the respective TRIAC dimmer; converting the first signal to a second signal that has a DC parameter comprises generating one or more second signals each of which having a DC parameter based on a combination of the plurality of first signals; and controlling operations of a load based at least in part on the second signal comprises controlling an intensity of emitted light, a color of the emitted light, or both, of one or more LEDs based at least in part on the one or more second signals.

In one embodiment, receiving a user-adjustable first signal from a dimmer comprises receiving a user-adjustable first signal from a TRIAC dimmer, the first signal having an AC parameter that is adjustable by a user input to the TRIAC dimmer; converting the first signal to a second signal comprises converting the first signal to a plurality of second signals, each of the plurality of second signals having a respective DC parameter; and controlling operations of a load based at least in part on the second signal comprises controlling an intensity of emitted light, a color of the emitted light, or both, of one or more LEDs based at least in part on the plurality of second signals.

### CONCLUSION

The above-described techniques pertain to techniques of controlling operations of LED lighting by using the output of a TRIAC dimmer not as a power source but as a lighting control signal. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

It is appreciated that the illustrated apparatus 100 and apparatus 200 are each one example of a suitable implementation of the proposed technique and is not intended to suggest any limitation as to the scope of use or functionality of the various embodiments described. Any variation of the disclosed embodiments made by a person of ordinary skill in the art shall be deemed to be within the spirit of the present disclosure, and thus shall be covered by the scope of the present disclosure.

What is claimed is:

1. A method comprising:
receiving a user-adjustable first signal from a dimmer, the first signal having an alternating current (AC) parameter that is adjustable by a user input to the dimmer;
converting the first signal to a second signal that has a direct current (DC) parameter; and
controlling operations of a load based at least in part on the second signal.

2. The method as recited in claim 1, wherein converting the first signal to a second signal comprises converting the first signal to a low-voltage DC signal using a photocoupler, a transformer, a heat-sensing circuit, a motor speed-sensing circuit, a resistor-capacitor (RC) circuit, a circuit that senses an electrical or magnetic parameter of the first signal, or a combination thereof.

3. The method as recited in claim 1, wherein controlling operations of a load based at least in part on the second signal comprises generating a third signal based at least in part on the second signal to control the load, the third signal comprising a pulse-width modulated (PWM) signal, a parallel digital signal, a serial digital signal, a signal having a DC voltage variable between 0 volt and 10 volt, a voltage signal having varying DC voltage levels, a signal representative of an impedance value, or a combination thereof.

4. The method as recited in claim 1, wherein controlling operations of a load based at least in part on the second signal comprises:
receiving a first source of power at a controller unit that is coupled to the power supply unit;
receiving a second source of power at a power supply unit, the second source of power different from the first source of power; and
generating a third signal, by the controller unit based on the second signal, to adjust an output of the power supply unit which controls the operations of the load.

5. The method as recited in claim 1, wherein:
receiving a user-adjustable first signal from a dimmer comprises receiving the user-adjustable first signal from a triode-for-alternating-current (TRIAC) dimmer; and
controlling operations of a load based at least in part on the second signal comprises controlling an intensity of emitted light, a color of the emitted light, or both, of one or more light-emitting diodes (LEDs) based at least in part on the second signal.

6. The method as recited in claim 1, wherein:
receiving a user-adjustable first signal from a dimmer comprises receiving a respective user-adjustable first signal from each of a plurality of triode-for-alternating-current (TRIAC) dimmers, each of the plurality of first signals having a respective AC parameter that is adjustable by a respective user input to the respective TRIAC dimmer;
converting the first signal to a second signal that has a DC parameter comprises generating one or more second signals each of which having a DC parameter based on a combination of the plurality of first signals; and
controlling operations of a load based at least in part on the second signal comprises controlling an intensity of emitted light, a color of the emitted light, or both, of one or more light-emitting diodes (LEDs) based at least in part on the one or more second signals.

7. The method as recited in claim 1, wherein:
receiving a user-adjustable first signal from a dimmer comprises receiving a user-adjustable first signal from a triode-for-alternating-current (TRIAC) dimmer, the first signal having an AC parameter that is adjustable by a user input to the TRIAC dimmer;
converting the first signal to a second signal comprises converting the first signal to a plurality of second signals, each of the plurality of second signals having a respective DC parameter; and
controlling operations of a load based at least in part on the second signal comprises controlling an intensity of emitted light, a color of the emitted light, or both, of one or more light-emitting diodes (LEDs) based at least in part on the plurality of second signals.

8. An apparatus comprising:
a translator unit that, in response to receiving a first signal that is sinusoidal in nature with a user-adjustable duty cycle, generates a second signal, the second signal comprising a pulse-width modulated (PWM) signal, a parallel digital signal, a serial digital signal, a signal having a DC voltage variable between 0 volt and 10 volt, a voltage signal having varying DC voltage levels, a signal representative of an impedance value, or a combination thereof; and
a power supply unit, coupled to the translator unit, that generates a third signal that controls operations of a load in response to receiving the second signal and being coupled to the load, the third signal being variable according to a setting of the second signal.

9. The apparatus as recited in claim 8, wherein the translator unit comprises:
a signal processing unit that generates a fourth signal that is direct current (DC) in nature in response to receiving the first signal; and
a controller unit, coupled to the signal processing unit, which generates the second signal in response to receiving the fourth signal.

10. The apparatus as recited in claim 9, wherein the signal processing unit generates the fourth signal using a photocoupler, a transformer, a heat-sensing circuit, a motor speed-sensing circuit, a resistor-capacitor (RC) circuit, a circuit that senses an electrical or magnetic parameter of the first signal, or a combination thereof.

11. The apparatus as recited in claim 8, wherein the power supply unit comprises a controllable power supply unit, coupled to receive the second signal and a user-input control signal, which generates the third signal in response to receiving the second signal and the user-input control signal.

12. The apparatus as recited in claim 8, wherein the translator unit transmits the second signal wirelessly, and wherein the power supply unit receives the second signal wirelessly.

13. The apparatus as recited in claim 8, further comprising:
one or more dimmer units coupled to the translator unit, each of the one or more dimmer units generating a respective first signal according to a setting of a respective user input in response to receiving the respective user input; and
at least one light-emitting diode (LED) as the load coupled to receive the third signal from the power supply unit,
wherein the translator unit is coupled to receive the one or more first signals from the one or more dimmer units and generates the second signal according to a combination of the one or more first signals.

14. An apparatus comprising:
a dimmer unit that, in response to receiving a user input, generates a first signal, the first signal being sinusoidal in nature and having a duty cycle adjustable according to a setting the user input; and
a translator unit, coupled to the dimmer unit, that generates a second signal in response to receiving the first signal, the second signal comprising a pulse-width modulated (PWM) signal, a parallel digital signal, a serial digital signal, a signal having a DC voltage variable between 0 volt and 10 volt, a voltage signal having varying DC voltage levels, a signal representative of an impedance value, or a combination thereof.

15. The apparatus as recited in claim 14, wherein the translator unit is configured to receive a plurality of output signals from a plurality of dimmer units and generate the second signal according to a combination of the plurality of output signals, each of the output signals being sinusoidal in nature and having a respective user-adjustable duty cycle.

16. The apparatus as recited in claim 14, wherein the translator unit is configured to receive one or more output signals from one or more dimmer units and generate respective one or more second signals according to a combination of the one or more output signals, each of the one or more output signals being sinusoidal in nature and having a respective user-adjustable duty cycle.

17. The apparatus as recited in claim 14, wherein the translator unit comprises:
a signal processing unit that generates a third signal that is direct current (DC) in nature in response to receiving the first signal; and
a controller unit, coupled to the signal processing unit, which generates the second signal in response to receiving the third signal.

18. The apparatus as recited in claim 15, wherein the signal processing unit generates the fourth signal using a photocoupler, a transformer, a heat-sensing circuit, a motor speed-sensing circuit, a resistor-capacitor (RC) circuit, a circuit that senses an electrical or magnetic parameter of the first signal, or a combination thereof.

19. The apparatus as recited in claim 14, further comprising:
a power supply unit, coupled to the translator unit, that generates a fourth signal to power a load in response to receiving the second signal and being coupled to the load, a value of a parameter of the fourth signal being set according to the second signal.

20. The apparatus as recited in claim 19, further comprising:
one or more light-emitting diodes (LEDs) as the load coupled to be powered by the fourth signal of the power supply unit, the fourth signal controlling an intensity of light emitted by the one or more LEDs, a color of the light emitted by the one or more LEDs, or both.
